(19) United States
(12) Patent Application Publication
(10) Pub. No.: US 2017/0037662 A1
(43) Pub. Date: Feb. 9, 2017

(54) Shielded Lock Hasp for Vehicle Door

(71) Applicant: Timothy J. Braun, Brookfield, WI (US)

(72) Inventor: Timothy J. Braun, Brookfield, WI (US)

(21) Appl. No.: 15/219,937

(22) Filed: Jul. 26, 2016

Related U.S. Application Data
(60) Provisional application No. 62/201,685, filed on Aug. 6, 2015.

(51) Int. Cl. E05B 77/44; E05B 83/02; B60J 5/00; E05B 67/36; E05B 77/46; E05B 17/20; E05B 67/38; E05B 83/12

(52) U.S. Cl. CPC E05B 77/44; E05B 67/383; E05B 83/02; E05B 83/12; E05B 67/36; E05B 77/46; E05B 17/2003; E05B 17/2084; B60J 5/00; E05B 2067/386

(57) ABSTRACT

Locking hasp brackets for a vehicle door are secured to the vehicle by the fasteners that secure the latch and strike for the door and extend through the crack at the edge of the door when the door is shut to a tab that projects beyond the outer side of the vehicle. A base wall is fixed to the tab in a lateral plane that is parallel to the axes of the fastener holes for the fasteners that secure the brackets and closely adjacent to the outside of the vehicle, and side walls extend from the periphery of the base wall so as to at least partially enclose the sides of the tab and create a protected space within which a puck lock or padlock resides that secures the tabs of the two brackets to one another.

### CROSS-REFERENCE TO RELATED APPLICATIONS

This application claims the benefit of U.S. Provisional Patent Application No. 62/201,685, filed Aug. 6, 2015, the disclosure of which is hereby incorporated by reference for all purposes.

### STATEMENT CONCERNING FEDERALLY SPONSORED RESEARCH OR DEVELOPMENT

Not applicable.

### FIELD OF THE INVENTION

This invention relates to a lock hasp particularly adapted for vehicle doors.

### BACKGROUND OF THE INVENTION

Tradesman vans are common and are often provided with auxiliary door locks commonly known as puck locks. The puck lock, which is the shape of a hockey puck, protects its inner locking components and is difficult for a thief to defeat. That difficulty then drives the thief to try to defeat the hasp, which can be the weakest link in the security system.

Conventional puck lock hasps have been made of steel plate that is secured to the outside surface of one or both doors by carriage bolts or other headless fasteners that extend through the plate and through the plane of the door panel. The plates may have cylindrical shielding sections welded or otherwise affixed to them that enclose a space in which the puck lock resides.

In another type of hasp disclosed in U.S. Pat. No. 8,496,276 the hasp is made up of two stainless steel brackets that extend into the crack between the doors or between a single door and a door threshold. The brackets have bolt holes through them so that the bolts extend into the edge of the door or into the handle side door jamb. In the case of barn doors in the rear of a van, one bracket has bolts that extend into the edge of one door and the other bracket is secured by bolts that extend into the edge of the other door.

These brackets extend from the crack between the door and the jamb, or between the barn-type doors and beyond the plane of the side of the vehicle to a hasp portion with a tab to which the puck lock or padlock is attached. Because both brackets have to extend through the crack, each is of a relatively thin cross section. That thin cross section makes it easy for a thief with a hacksaw or a power cutter to hack through the hasp and gain entry into the vehicle.

### SUMMARY OF THE INVENTION

The invention provides a locking bracket particularly adapted for vehicle doors that includes a first bracket adapted for attachment to a door or door jamb of the vehicle. The bracket has a locking tab that extends beyond an outer side of the vehicle. A base wall extends from the tab at a position at which it would abut the outer side of the vehicle or be in very close proximity thereto when the bracket is attached to the vehicle. This is such a tight fit that it prevents slipping a hacksaw blade in between the base wall and the side panel of the door so as to permit cutting through only the thin cross-section of the tab to defeat the lock.

Preferably the base wall extends outward from the tab and from the base wall extends a first side wall generally perpendicular to the base wall away from the base wall so as to create a space shrouding the projecting portion and outer end of the tab laterally. The bracket has bolt holes with an axis that extends generally parallel to the plane of the base wall so that the bracket can be attached to the door using either the fasteners of the door strike or the fasteners of the door latch or other fasteners that attach to the edge of the door inward of the outer surface of the door. The bracket extends outwardly from where it is attached to the door through the vertical crack of the door (the crack being either between two doors or a door and the handle side door jamb) that exists when the door is closed. Another similar bracket is attached to either the other door in the case of barn doors at the rear of a van or to the handle side jamb in the case of a passenger door, driver door, or sliding door.

The present invention improves upon the type of hasps with brackets that are bolted to the edge of the door wherein the fasteners that secure the strike or latch also secure the bracket to the vehicle and the brackets extend out through the crack at the edge of the door. The present invention modifies such brackets by adding a shield that includes a base wall and side walls that together define a shielded space in which the hasp portions of the brackets reside. The inner edge of the base extends from the bracket closely adjacent or abutting the outer surface of the vehicle so that a saw blade (typically 0.020-0.027 inches thick) cannot be slipped in between the base plate and the vehicle body to cut through only the thin cross-section of the bracket. Thus, preferably, the base wall is positioned along the length of the tab so it is spaced from the outside of the vehicle less than the width of a hack saw blade, i.e., less than 0.020-0.27 inches.

In a preferred form, the side shields extend from the base and may also extend from the bracket and shield the sides of the pocket in which the hasp portions reside to provide protection to the puck lock or padlock securing the hasp portions to each other.

The improvements provided by the invention also hamper a thief from hammering and prying the lock and tabs until the tabs would break. They provide shielding against this form of defeat, and also strengthen the bracket to withstand more abuse.

The bracket may have two side wall portions, with a space in between the two side wall portions wherein a key can be inserted into the side of a puck lock in the application where a puck lock is used in combination with the brackets.

Preferably, the brackets are made of stainless steel, which is particularly tough and difficult to cut or break with the type of tools thieves normally use to break into vehicles.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIGS. 1-3 show respective front, side, and top plan views of one bracket of a pair of brackets of the invention, and FIGS. 4-6 show the other bracket of the pair in respective front, side, and top plan views, particularly:

FIG. 1 is a front plan view of a bracket of the invention;

FIG. 2 is a side plan view of a bracket of the invention;

FIG. 3 is a top plan view of a bracket of the invention;

FIG. 4 is a front plan view of the other bracket of the pair of brackets of the invention;

FIG. 5 is a side plan view of the bracket of FIG. 4;

FIG. 6 is a top plan view of the bracket of FIGS. 4 and 5;

FIG. 7 is a perspective view of the bracket of FIGS. 1-3;

FIG. 8 is a perspective view of the bracket of FIGS. 4-6;

FIG. 9 is a perspective view of the bracket of FIGS. 1-3 and 7 installed on a rear barn door of a van-type vehicle, with the bracket secured between the strike and the wall of the peripheral edge of the door using the fasteners that secure the strike to the door;

FIG. 10 is a perspective view of the bracket of FIGS. 1-4 and 8 installed on a rear barn door of a van-type vehicle, with the bracket secured against the wall of the peripheral edge of the door using the fasteners that secure the latch to the door;

FIG. 11 is a perspective view of both brackets installed on a pair of barn doors of a vehicle; and

FIG. 12 is a horizontal cross-sectional view through the center of the brackets of FIG. 11 and showing a puck lock in phantom inside the side walls of the brackets.

### DETAILED DESCRIPTION OF THE PREFERRED EMBODIMENT

FIGS. 1-6 depict a pair of brackets 10 and 110 that employ the present invention. FIGS. 1-3 show one of the brackets, 10, and FIGS. 4-6 show the other bracket 110. The bracket 10 shown in FIGS. 1-3 is very similar to the bracket 110 shown in FIGS. 4-6. Only bracket 10 will be described in detail and the differences of bracket 110 from 10 will also be described. The elements of bracket 110 will be described with the same reference numbers as used with respect to bracket 10 plus 100.

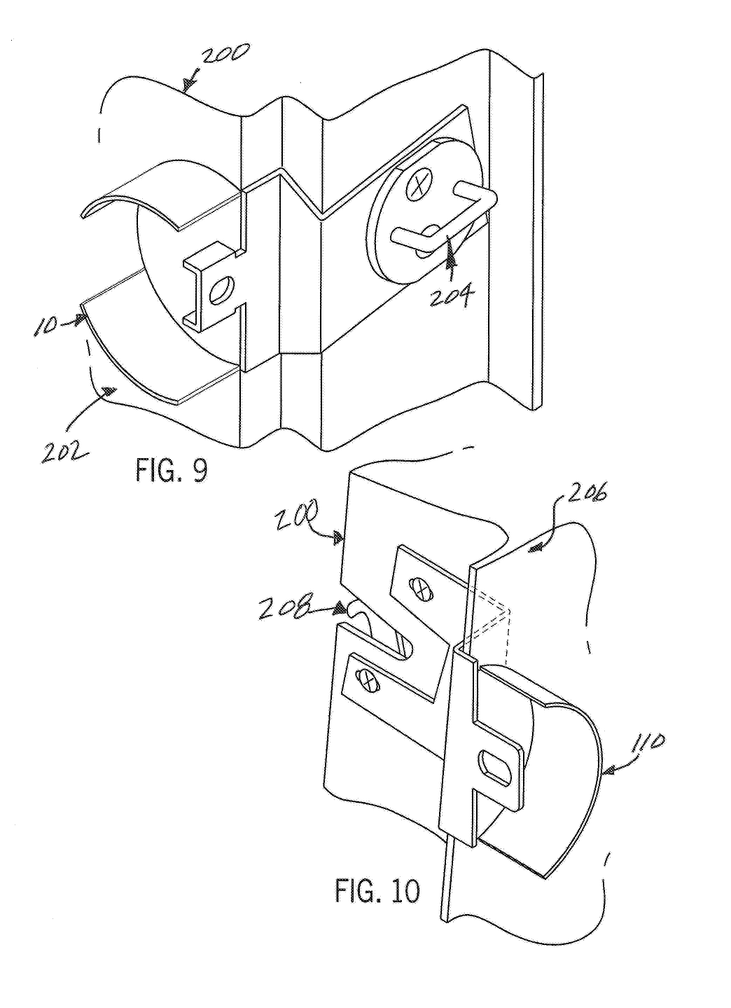

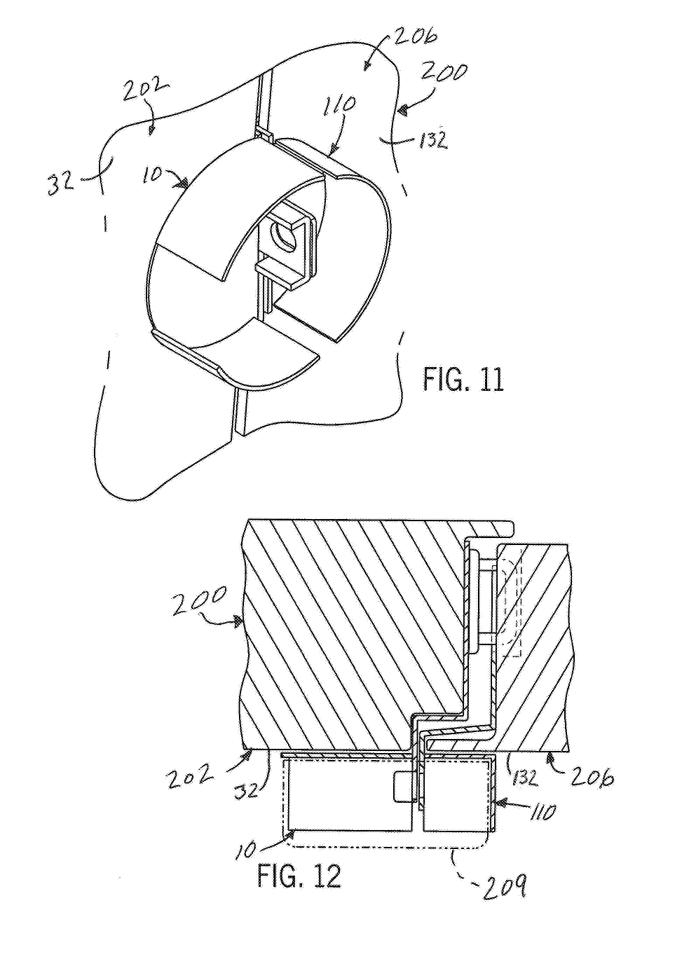

Bracket 10 has a dogleg-shaped portion 12 that is stamped from a piece of stainless steel plate. The dogleg-shaped portion 12 includes longitudinal portion 14, lateral portion 16, and hasp portion 18, which extends longitudinally and includes tab 19 that extends beyond the side of the vehicle 200 and beyond a laterally extending base plate 30. Tab 19 is generally T-shaped and has reinforcement ears 21 bent out laterally at its end, adjacent to where hole 24 with lateral axis 25 resides. Attachment portion 14 has bolt holes 20 each having an axis 23 that extends laterally, generally parallel to the plane of the base plate 30, so that the bracket 10 can be secured to the edge of the door 202 (FIG. 9) or door jamb on the handle side of the door using the fasteners that attach the strike 204. The portion 12 may go between the strike plate and the sheet metal edge of the door or the edge of the door jamb of the vehicle frame. In the bracket 110, the holes 120 are adapted to be secured by the fasteners to the other door 206 (FIG. 10) that secure the latch 208 that latches onto the strike 204, and therefore, the portion 114 has a U-shaped space 127 that creates a pocket in which the opening to the latch resides when the bracket is installed. Usually the brackets extend toward the outside of the door from their mounting to the door to extend beyond an outside surface of the door, but could extend to the inside of the vehicle so as to extend beyond an inside surface of the door, where the lock would be applied to them. The dogleg portions 12 and 112 thus far described are similar to the brackets described in U.S. Pat. No. 8,496,276, the disclosure of which is hereby incorporated by reference for all purposes including showing how the dogleg portions of the brackets are attached to the vehicle.

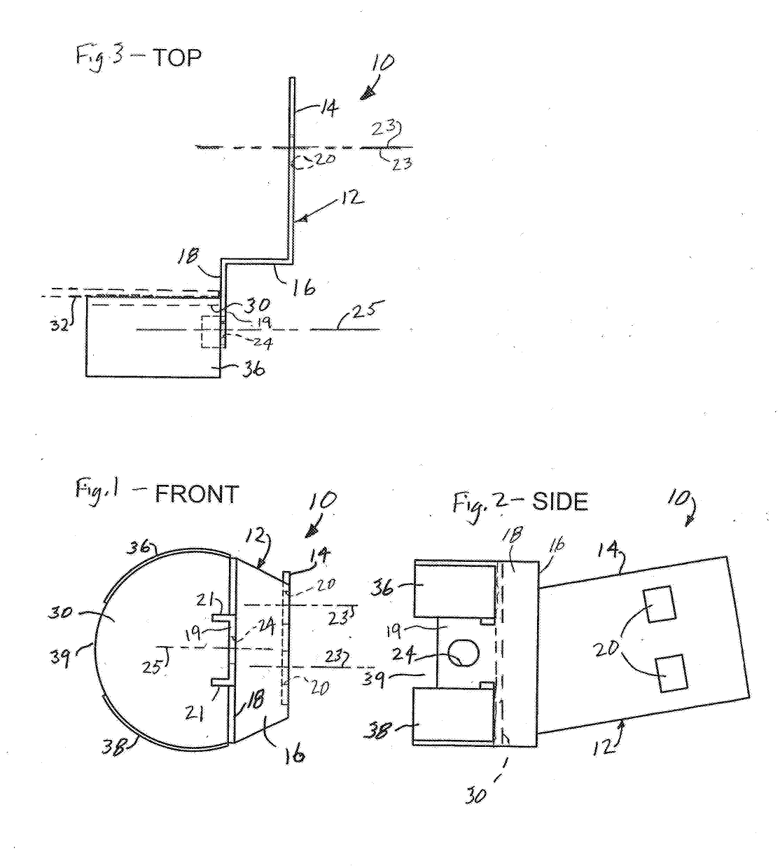

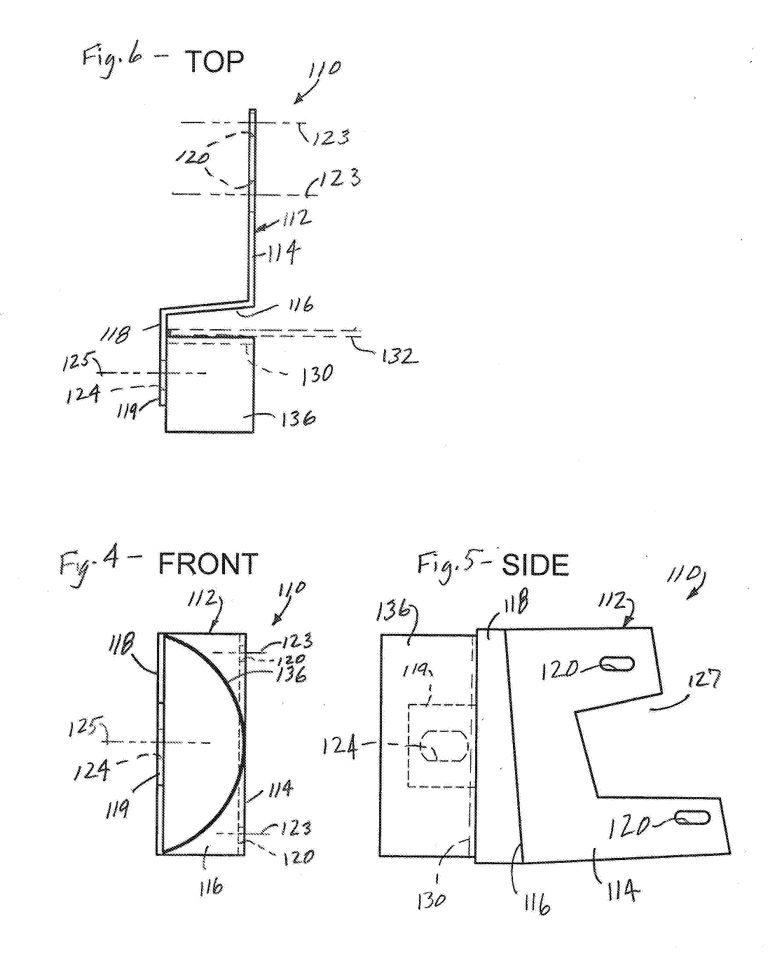

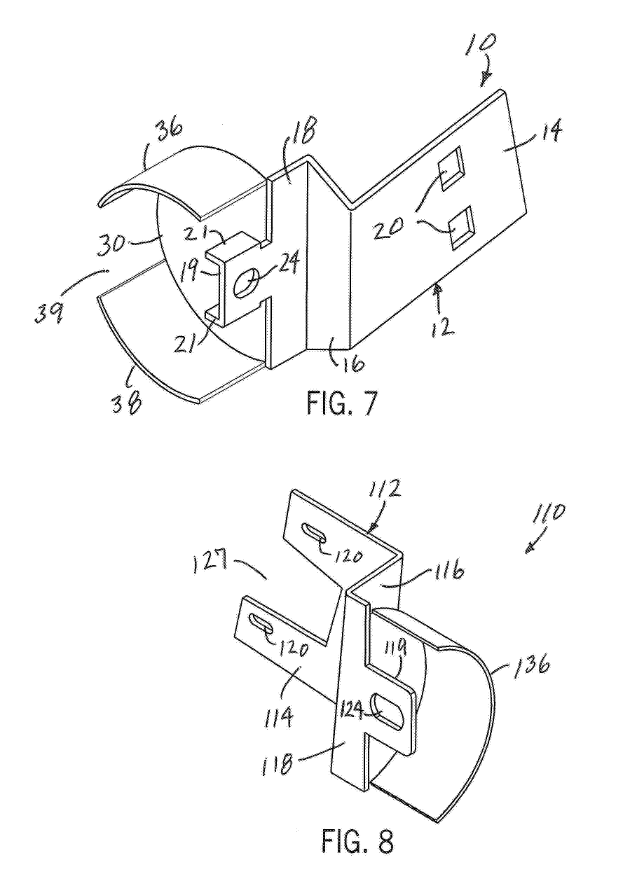

When the door or doors are shut the two hasp portions 18 and 118 come together in close side-by-side relationship to one another (FIGS. 11 and 12) so that a padlock or puck lock 209 (FIG. 12) can be put through the holes 24 and 124 to attach the two hasp portions to one another. The invention herein modifies the dogleg section to include a base wall 30 extending from the hasp portion 18 so as to be parallel to the vehicle body (outer side of the door or outer side of the jamb) and in very close relationship to the vehicle body. The base wall 30 may in fact be abutting the exterior surface of the vehicle body so that it makes it extremely difficult to slip a saw blade between the base wall 30 and the side surface 32 or 132 of the respective vehicle door 202 or 206, but if a blade does get behind the wall 30 the thief will have to cut through the entire length of stainless steel bracket 14 shown in FIG. 2 (or 114 in FIG. 5) instead of being able to cut through just the smaller bracket 19 (FIGS. 1 and 2, or 119 in FIGS. 4 and 5), which extends much less in height than bracket 14, 114 in the hasp portion 18, 118 just behind the wall 30, 130.

The base wall 30 may be a flat circular segment as illustrated in FIGS. 1 and 4 and have two side walls 36, 38 in the case of the bracket 10, or one side wall 136 in the case of the bracket 110, affixed at the periphery of the base wall 30 or 130 respectively. In the bracket 10, there are two side walls 36 and 38 with a space 39 between them so as to provide access to the key hole of a puck lock through the space 39 but no such space is necessary on the other bracket 110 and so it has a single side wall 136 that goes around essentially the entire periphery of the base plate 130. The side walls may be secured to the base plate and to the hasp portion 18 by welding and the base plate 30 may be attached to the hasp portion 18 by welding. Preferably, the entire bracket is made of stainless steel because stainless steel is very difficult to cut and resistant to hammering and prying.

The base plate and side plate or plates provide a space in which the projecting tab portions 19, 119 of the hasp portions 18, 118 reside to protect the tabs and the padlock or puck lock contained within the space against cutting, prying, hammering, and other tampering and abuse.

The invention provides an extreme impact in a sense of overall security. It provides a major increase in area that is required to be cut by a potential thief. The original 1¼″ tab remains, however there is an addition of nearly two times the material that must be cut through to get beyond that half of the shell. Overall the invention adds about four inches (two inches on each bracket) of material (stainless steel in the preferred embodiment) that needs to be cut before the lock will be rendered useless. Beyond offering superior protection against being cut off, the 1½″ outer shell provided by the sidewalls provides a better barrier against prying and impacts from a sledgehammer. By making the shield stainless steel, there is an inherent gain in strength and longevity versus other materials that could have been used. Another feature is the ease with which existing brackets for other makes and models of vehicles can be modified to incorporate the invention.

A preferred embodiment of the invention has been described in considerable detail. Many modifications and variations to the preferred embodiment described will be apparent to a person of ordinary skill in the art. Therefore, the invention should not be limited to the embodiment described.

I claim:

1. In a locking hasp for a vehicle door in which brackets of the hasp have bolt holes through which fasteners extend that secure a latch and strike for the door to the vehicle, said bolt holes having lateral axes, wherein the brackets extend longitudinally from the bolt holes through a crack at the edge of the door when the door is closed to a tab that has a locking shackle hole beyond a side surface of the vehicle, the improvement wherein a laterally extending base plate is fixed to the tab at a position along the length of the tab between the hole in the tab and the side surface of the vehicle adjacent to the side surface of the vehicle when the bracket is installed on the vehicle.

2. The improvement of claim 1, wherein the base plate is spaced less than the thickness of a typical hack saw blade from the side surface of the vehicle when the bracket is installed on the vehicle.

3. The improvement of claim 1 further comprising a longitudinally extending side wall affixed to the base plate and extending therefrom so as to define a space around the tab that is at least partially enclosed.

4. The improvement of claim 3, wherein the bracket has two said side walls with a space between them adapted for accessing the keyhole of a lock secured to the tab.

5. The improvement of claim 3, wherein the side wall is a cylindrical section.

6. The improvement of claim 1, wherein the base plate is welded to the tab.

7. The improvement of claim 1, wherein the base wall is flat.

8. The improvement of claim 7, wherein the base wall is a circular section.

9. The improvement of claim 1, wherein the bracket is made of stainless steel.

10. The improvement of claim 1, wherein the bracket is one of a pair of said brackets, both of which include the improvement of claim 1.

11. A pair of said brackets as claimed in claim 10, further including a lock for locking the tabs of the two brackets together.

12. The brackets and lock of claim 11, wherein the lock is a puck lock.

13. The improvement of claim 1, further comprising a vehicle to which the bracket is attached.

14. A bracket as claimed in claim 1, wherein the height of the bracket is greater behind the base wall than in front of the base wall.

15. A vehicle locking hasp having a dogleg-shaped section with lateral bolt holes through an inner end section for attaching the bracket to a vehicle and with a tab at an outer end of the bracket, wherein the bracket comprises a shield affixed to the tab including a base wall and a side wall that defines a space in which a hole in the tab resides.

16. Two brackets as claimed in claim 15, in which the holes are aligned when the brackets are affixed to the vehicle with the door closed.

17. Two brackets as claimed in claim 16, further comprising a lock.

18. Two brackets and a lock as claimed in claim 17, further comprising a vehicle to which the brackets are attached.

19. A bracket as claimed in claim 15, wherein the height of the bracket is greater behind the base wall than in front of the base wall.

20. A vehicle comprising:
an over-the-road vehicle comprising a frame bounding a cargo space and at least one door that is movable between closed and open positions to selectively block and allow access to the cargo space, the at least one door comprising a first door that has oppositely facing inside and outside surfaces and a peripheral edge between the inside and outside surfaces;
a first lock hasp bracket secured to the at least one door;
a second lock hasp bracket secured to one of: a) the vehicle frame; and b) a second door, to releasably maintain the first door in its closed position,
wherein the first lock hasp bracket is secured to the vehicle using at least one fastener directed through the peripheral edge and secures the first lock hasp bracket to the first door;
the secured first and second lock hasp brackets cooperating to be maintained together either inside or outside of the cargo space to thereby prevent the first door in its closed position from being moved into its open position,
wherein the first and second lock hasp brackets extend longitudinally from being adjacent to the peripheral edge of the first door through a crack at the edge of the first door when the first door is closed to a tab that has a locking shackle hole beyond one of the side surface of the door; and
wherein a laterally extending base plate of each bracket is fixed to the tab of the bracket at a position along the length of the tab between the hole in the tab and the one side surface of the door.
